(19) United States
(12) Patent Application Publication
(10) Pub. No.: US 2025/0256349 A1
(43) Pub. Date: Aug. 14, 2025

(54) LASER BEAM MACHINING METHOD TARGETED AT CHALCOGENIDE MATERIALS AND INTEGRATED PHOTONIC DEVICE

(71) Applicant: SUN YAT-SEN UNIVERSITY, Guangzhou (CN)

(72) Inventors: Zhaohui Li, Guangzhou (CN); Yan Li, Guangzhou (CN); Shunyu Yao, Guangzhou (CN); Yuru Li, Guangzhou (CN); Hongfei Chen, Guangzhou (CN); Zhen Hu, Guangzhou (CN)

(21) Appl. No.: 19/174,069

(22) Filed: Apr. 9, 2025

Related U.S. Application Data
(63) Continuation of application No. PCT/CN2024/094120, filed on May 20, 2024.

(30) Foreign Application Priority Data
Dec. 11, 2023 (CN) 202311687972.8

(51) Int. Cl. B23K 26/00; B23K 26/06; B23K 26/352; B23K 101/36; B23K 103/00

(52) U.S. Cl. CPC B23K 26/0006; B23K 26/0626; B23K 26/352; B23K 2101/36; B23K 2103/50

(57) ABSTRACT

Embodiments of this application provide a laser beam machining method targeted at chalcogenide materials and an integrated photonic device, relating to the technical fields of integrated photonic chip machining. The laser beam machining method targeted at chalcogenide materials includes: acquiring a dielectric substrate with a preset size, and cleaning the dielectric substrate; preparing a uniform and dense sulfide film on a surface of the dielectric substrate; obtaining a laser spot with a preset energy distribution pattern according to a preset machining pattern; generating laser spot scanning parameters according to the preset machining pattern; and carrying out etching-free laser oxidation machining on the sulfide film through the laser spot according to the spot scanning parameters to obtain a chalcogenide integrated photonic device. The laser beam machining method targeted at chalcogenide materials can significantly simplify the machining flow of integrated photonic chips and improve the machining efficiency of photonic chips.

### CROSS-REFERENCE TO RELATED APPLICATIONS

The present application is a continuation application of PCT application No. PCT/CN2024/094120 filed on May 20, 2024, which claims the benefit of Chinese Patent Application No. 202311687972.8 filed on Dec. 11, 2023. The contents of all of the aforementioned applications are incorporated by reference herein in their entirety.

### TECHNICAL FIELD

The invention relates to the technical field of integrated photonic chip machining, and in particular to a laser beam machining method targeted at chalcogenide materials and an integrated photonic device.

### BACKGROUND

At present, in the field of integrated photonic chip fabrication, there are three main types of micro-scale dielectric modulation technical solutions for photoexcited optical materials: semiconductor micro- and nanofabrication technology targeted at photolithography, dielectric modulation technology targeted at femtosecond laser modification and three-dimensional printing technology targeted at photoresist.

For silicon-based photonic integrated devices with a mature photolithography process, the semiconductor micro- and nanofabrication technology targeted at photolithography can realize large-scale and low-cost fabrication by utilizing industrial standards, and it is the mainstream solution for photonic integrated chip machining at present. However, the semiconductor micro- and nanofabrication technology targeted at photolithography has high requirements for hardware, and the micro- and nanofabrication equipment is expensive and difficult to purchase and also has demands for operation and maintenance, which makes micro- and nanofabrication high in comprehensive cost. Moreover, the machining process is complicated. The standard etching process usually includes 5 to 6 steps, and cannot form the device at one time.

The dielectric modulation technology targeted at femtosecond laser modification uses a femtosecond laser to irradiate the inside of a transparent material. By utilizing the characteristics of ultrastrong peak energy of the laser beam, the multi-photon nonlinear absorption of the incident laser beam by the material is induced to make the material ionized, so that the material in the focused irradiated region is modified and the refractive index is changed. By controlling the modified region of the material, optical devices such as waveguides are machined. However, the dielectric modulation technology targeted at femtosecond laser modification needs to use the expensive femtosecond laser as the machining light source, which makes the machining cost higher. In addition, the femtosecond laser modification has a limited dielectric modulation depth for the material. Usually, after the transparent material is modified by the femtosecond laser, its refractive index changes only in 10⁻³ orders of magnitude, and such a small refractive index difference can only meet the requirements of devices such as waveguides, optical switches and so on.

As for the three-dimensional printing technology targeted at photoresist, by utilizing the two-photon absorption effect of photoresist, femtosecond laser pulses are converged and allowed to irradiate the inside of the photoresist so as to selectively harden different regions of the photoresist. The hardening occurs only in the three-dimensional region where the laser beam focuses. Then, all the unhardened material is removed to expose the constructed three-dimensional structure. However, the three-dimensional printing technology targeted at photoresist has high requirements for hardware, and needs to use a femtosecond laser as the machining light source, which makes the cost higher. Moreover, the machining steps are complicated. Similar to the semiconductor micro- and nanofabrication technology, the three-dimensional printing technology targeted at photoresist needs to remove the excess photoresist after the completion of the machining, and also needs development and photoresist removal, so it cannot directly form the device at one time.

### SUMMARY

In order to overcome the defects in the prior art, the invention provides a laser beam machining method targeted at chalcogenide materials and several integrated photonic devices targeted at the machining method, which significantly simplifies the machining flow of integrated photonic chips and improves the machining efficiency of photonic chips.

In order to solve the above technical problem, the invention adopts the following technical solution:

In a first aspect, this application provides a laser beam machining method targeted at chalcogenide materials, including the following steps:
acquiring a dielectric substrate with a preset size, and cleaning the dielectric substrate;
preparing a uniform and dense sulfide film on a surface of the dielectric substrate;
obtaining a laser spot with a preset energy distribution pattern according to a preset machining pattern;
generating laser spot scanning parameters according to the preset machining pattern; and
carrying out etching-free laser oxidation machining on the sulfide film through the laser spot according to the laser spot scanning parameters to obtain a chalcogenide integrated photonic device.

During the above implementation process, according to the laser beam machining method targeted at chalcogenide materials, the laser spot with the preset energy distribution pattern is obtained via the preset machining pattern, the scanning mode of the laser spot is designed according to the preset machining pattern, and further, the etching-free laser oxidation machining is carried out on the sulfide film, which realizes micro-scale photoinduced localized oxidation on the chalcogenide materials and accurately modulates the oxidation degree of the sulfide film, thereby changing the dielectric constant of the sulfide film. Thus, targeted at the micro-scale pattern (preset machining pattern), the focused laser spot is allowed to directly irradiate the continuous and smooth surface of the sulfide film so as to form the micro-scale oxidation region pattern of any required shape at one time. This method does not need a photoresist or other forms of masks, nor need etching, carries out machining directly on the surface of the chalcogenide material film to form the preset machining pattern at one time, so the machining process is simple. Therefore, the laser beam machining method targeted at chalcogenide materials can simplify the machining flow of integrated photonic chips and improve the machining efficiency.

Further, an extinction coefficient of a sulfide material in a target band is greater than or equal to 0.05, and the sulfide material is one or more of antimony sulfide, germanium tellurium sulfur, germanium antimony tellurium, germanium arsenic sulfur and germanium tellurium selenium. The target band is one of a visible light band, a short wave infrared band, a medium wave infrared band and a long wave infrared band.

Further, a laser light source of the laser spot is a continuous-wave laser, and a wavelength of the continuous-wave laser is selected from any one of wavelengths with the extinction coefficient of the sulfide material being greater than or equal to 0.05.

Further, a machining region of the sulfide film is heated up under the irradiation of the laser spot, and the heated machining region reacts with oxygen ions in a machining environment and undergoes oxidation. The machining environment includes one or more of air, oxygen, water and an oxygen ion solution. A first material refractive index of the irradiated region of the sulfide film before oxidation is different from a second material refractive index after oxidation, and a difference between the first material refractive index and the second material refractive index at a working band is not less than 0.1.

Further, the preset machining pattern is obtained by changing energy distribution of the laser spot and changing a scanning mode of the laser spot.

Further, an oxidation degree of the material in the machining region of the laser spot may be modulated in multiple stages by adjusting energy, an irradiation time and the scanning mode of the laser spot.

Further, a first film thickness of the machining region of the sulfide film before laser beam machining is only slightly different from a second film thickness after laser beam machining, and a ratio of the second film thickness to the first film thickness is 0.8 to 1.2.

Further, the preset machining pattern includes one or more of a circle, an ellipse, a rectangle, a cross, a circular ring, an elliptical ring, a square ring, a negative cross pattern, a circular array, an elliptical array, a rectangular array, a cross array, a circular ring array, an elliptical ring array, a square ring array and a negative cross pattern array.

Further, if the chalcogenide materials of the selected sulfide film have phase-change characteristics, then the integrated photonic device prepared by the laser oxidation machining has the optical response characteristic of being programmable and nonvolatile, and the phase-change material includes one or more of antimony sulfide and antimony selenide.

In a second aspect, this application provides an integrated photonic device. The integrated photonic device is prepared by the above laser beam machining method targeted at chalcogenide materials. During the preparation of the integrated photonic device, additional exposure and etching with or without a mask is not needed to be introduced.

Further, the integrated photonic device may be applied to many fields, such as spatial light field modulation, on-chip optical signal transmission and on-chip optical signal processing.

Further, the spatial light field modulation effect includes, but not limited to, light field amplitude modulation, light field phase modulation, light field polarization modulation, reflected light field focusing, reflected OAM vortex beam generation, etc.

Further, the on-chip optical signal transmission effect includes, but not limited to, an on-chip waveguide, an on-chip Mach-Zehnder interferometer, a waveguide light splitter, a polarization beam splitter, etc.

Further, when the chalcogenide material has phase-change characteristics and the phase of the material can be controlled by external excitation signals such as light, electricity and heat, the planar chalcogenide integrated photonic device has the optical response characteristics of being nonvolatile and programmable.

Further, the phase-change chalcogenide material includes, but not limited to, antimony sulfide, germanium antimony tellurium, etc.

Further, the optical response dynamic modulation effect includes, but not limited to, a spatial optical switch, a switching Fresnel lens, an integrated waveguide phase shifter, an adjustable Mach-Zehnder interference optical switch, a splitting-ratio-adjustable waveguide beam-splitting optical switch, etc.

In a third aspect, this application provides a laser beam machining apparatus targeted at chalcogenide materials, which is applied to the laser beam machining method targeted at chalcogenide materials according to any solution in the first aspect. The apparatus includes a machining light source, a beam modulation system, a convergence system, a sample fixing system and a white light observation system.

The machining light source is configured to output a laser beam.

The beam modulation system is arranged at an exit end of the machining light source and configured to modulate the laser beam into a laser spot with a preset energy distribution pattern.

The convergence system is arranged at an exit end of the beam modulation system and configured to converge the laser spot and image the laser spot to a surface of a to-be-machined sample.

The sample fixing system is arranged at an exit end of the convergence system and configured to fix the to-be-machined sample.

The white light observation system is arranged between the beam modulation system and the convergence system and configured to observe morphology of the machining region of the to-be-machined sample.

Further, the sample fixing system includes a three-axis translation stage, a pitch adjusting stage and a rotation adjusting stage which are sequentially stacked. The three-axis translation stage is configured to control a machining position of the to-be-machined sample. The pitch adjusting stage is configured to adjust a pitch angle of the to-be-machined sample. The rotation adjusting stage is configured to adjust a rotation angle of the to-be-machined sample.

The laser beam machining apparatus targeted at chalcogenide materials further includes a motorized power attenuator and a high-speed optical switch. The motorized power attenuator is connected with the machining light source and configured to modulate a laser power of the laser beam. The high-speed optical switch is connected with the machining light source and configured to modulate an on/off state of the beam.

The white light observation system further includes a beam splitter. The beam splitter is arranged between the beam modulation system and the convergence system. The beam splitter is configured to combine a collimated and parallel white light beam and the laser beam. The white light beam is used to irradiate the machining region of the to-be-machined sample, and the white light reflected beam of the to-be-machined sample is irradiated onto the white light observation system via the beam splitter.

Other features and advantages disclosed in this application will be set forth in the following specification, or some features and advantages can be inferred or ascertained from the specification, or can be learned by implementing the above technology disclosed in this application.

In order to make the aforementioned objectives, features and advantages of this application more comprehensible, the preferred embodiments are described in detail below with reference to the accompanying drawings.

### BRIEF DESCRIPTION OF DRAWINGS

In order to more clearly illustrate the technical solutions of the embodiments of this application, the accompanying drawings used in the embodiments of this application will be briefly described below. It should be understood that the following accompanying drawings show only certain embodiments of this application, and therefore, should not be considered as limiting the scope. Those skilled in the art can obtain other related drawings according to these drawings without any creative work.

FIG. 1 is a schematic flowchart of a laser beam machining method targeted at chalcogenide materials according to Embodiment 1 of this application;

FIG. 2 is a schematic flowchart of another laser beam machining method targeted at chalcogenide materials according to Embodiment 2 of this application;

FIG. 3 is a schematic structural view of a chalcogenide material laser oxidation machining apparatus according to Embodiment 3 of this application;

FIG. 4 shows schematic structural views of a planar chalcogenide integrated photonic device prepared by etching-free laser oxidation machining according to Embodiment 4 of this application;

FIG. 5 shows schematic structural views of a chalcogenide linear polarizer prepared by etching-free laser oxidation machining according to Embodiment 5 of this application;

FIG. 6 is a schematic diagram showing reflectivity spectra of the chalcogenide linear polarizer prepared by etching-free laser oxidation machining according to Embodiment 5 of this application;

FIG. 7 shows schematic structural views of a chalcogenide planar Fresnel zone plate prepared by etching-free laser oxidation machining according to Embodiment 6 of this application;

FIG. 8 is a light intensity distribution diagram of the chalcogenide planar Fresnel zone plate prepared by etching-free laser oxidation machining according to Embodiment 6 of this application;

FIG. 9 shows schematic structural views of a chalcogenide planar first-order OAM phase plate prepared by etching-free laser oxidation machining according to Embodiment 7 of this application;

FIG. 10 is a reflected far-field light intensity distribution diagram of the chalcogenide planar first-order OAM phase plate prepared by etching-free laser oxidation machining according to Embodiment 7 of this application;

FIG. 11 shows schematic structural views of a chalcogenide planar waveguide prepared by etching-free laser oxidation machining according to Embodiment 8 of this application;

FIG. 12 is a mode effective refractive index dynamic modulation effect diagram of the chalcogenide planar waveguide prepared by etching-free laser oxidation machining according to Embodiment 8 of this application;

FIG. 13 shows schematic structural views of a chalcogenide planar waveguide type phase-change optical phase shifter prepared by etching-free laser oxidation machining according to Embodiment 9 of this application;

FIG. 14 shows dynamic phase modulation effect diagrams of the chalcogenide planar waveguide type phase-change optical phase shifter prepared by etching-free laser oxidation machining according to Embodiment 9 of this application;

FIG. 15 shows schematic structural views of a chalcogenide planar waveguide type Mach-Zehnder interference optical switch prepared by etching-free laser oxidation machining according to Embodiment 10 of this application;

FIG. 16 is a dynamic modulation effect diagram of the chalcogenide planar waveguide type Mach-Zehnder interference optical switch device prepared by etching-free laser oxidation machining according to Embodiment 10 of this application;

FIG. 17 shows schematic structural views of a chalcogenide planar splitting-ratio-adjustable on-chip beam-splitting optical switch prepared by etching-free laser oxidation machining according to Embodiment 11 of this application;

FIG. 18 is a dynamic modulation effect diagram of the chalcogenide planar splitting-ratio-adjustable on-chip beam-splitting optical switch prepared by etching-free laser oxidation machining according to Embodiment 11 of this application; and

FIG. 19 is a dynamic polarization beam-splitting modulation effect diagram of the chalcogenide planar splitting-ratio-adjustable on-chip beam-splitting optical switch prepared by etching-free laser oxidation machining according to Embodiment 11 of this application.

Reference signs: 1, silicon substrate; 2, gold reflective layer; 3, aluminum oxide layer; 4, antimony sulfide; 5, antimony oxide; 6, planar structure array; 7, silicon dioxide substrate; 8, waveguide; 9, silicon dioxide buffer layer; 10, graphene heating plate; 11, metal N-electrode; 12, metal P-electrode; 13, input terminal P1; 14, output terminal P2; 15, straight waveguide; 151, first output straight waveguide; 152, second output straight waveguide; 16, beam-splitting waveguide; 17, beam-combining waveguide; 18, evanescent coupling waveguide; 100, machining light source; 200, beam modulation system; 300, convergence system; 400, sample fixing system; 500, white light observation system; 600, to-be-machined sample; 700, beam splitter.

### DETAILED DESCRIPTION OF EMBODIMENTS

The technical solutions in the embodiments of the invention will be clearly and completely described below with reference to the accompanying drawings in the embodiments of the invention. It is apparent that the described embodiments are only a part of the embodiments, rather than all of the embodiments of the invention. The invention will be described in one of embodiments with reference to specific implementations. The accompanying drawings are only for illustrative purposes, represent only schematic, not physical drawings, and are not to be construed as limiting the invention. In order to better illustrate the embodiments of the invention, some components in the accompanying drawings are omitted, enlarged or reduced, and do not represent the dimensions of the actual product. It can be understood for those skilled in the art that some well-known structures in the accompanying drawings and descriptions thereof may be omitted.

In the description of the invention, it should be understood that if the orientation or positional relationship indicated by the terms “up”, “down”, “left” and “right” is targeted at the orientation or positional relationship shown in the accompanying drawings, it is only for the convenience of describing the invention and simplifying the description, and does not indicate or imply that the device or element referred to must have a specific orientation, or be constructed and operated in a specific orientation. Therefore, the terms describing the positional relationship in the accompanying drawings are only used for illustrative purposes, and are not to be construed as limiting the invention. For those of ordinary skill in the art, the specific meaning of the above terms may be understood according to specific conditions. In addition, the terms “first” and “second” involved in the embodiments of the invention are merely used for descriptive purposes, and cannot be understood as indicating or implying relative importance or implicitly indicating the number of technical features indicated. Thus, the features defined with “first” and “second” may explicitly or implicitly include at least one such feature. In addition, “and/or” herein means that three parallel solutions are included. For example, “A and/or B” includes a solution A, a solution B, or a solution where both A and B are satisfied.

### Embodiment 1

This embodiment of this application provides a laser beam machining method targeted at chalcogenide materials and an integrated photonic device, which can be used for machining chalcogenide integrated photonic chips. The laser beam machining method targeted at chalcogenide materials is an etching-free laser beam machining method. A laser spot with a preset energy distribution pattern is obtained via a preset machining pattern, and etching-free laser oxidation machining is carried out on a sulfide film targeted at the laser spot, so that the oxidation degree of the surface of the sulfide film is accurately modulated on a micro-scale, thereby changing the dielectric constant of the sulfide film. The pattern is nonvolatile and can be formed at one time. Thus, the laser beam machining method can improve the machining efficiency.

Exemplarily, the nonvolatile dielectric tunability means that the dielectric constant of the optical material changes significantly by means of excitation by external laser irradiation, and when the excitation signal is canceled, the material continues to maintain the current dielectric properties after excitation. The formation at one time is the formation of a micro-scale pattern (preset machining pattern) at one time targeted at etching-free laser beam machining. The oxidation machining means that by using beam shaping technology, the focused laser spot is allowed to directly irradiate the continuous and smooth surface of the sulfide film so as to obtain the micro-scale oxidation region pattern of any required shape at one time.

Exemplarily, the laser beam machining method targeted at chalcogenide materials provided by this embodiment of this application does not need to use any photoresist or mask, is simple in machining process and can realize formation at one time. In the traditional micro- and nanostructure device machining technologies, EBL etching, ICP etching or wet etching targeted at photoresist and mask includes: preparation of mask, spin coating of photoresist, exposure, development, film deposition (or etching) and photoresist removal. The FIB etching without a mask and the DMD-based maskless photolithography also usually require standard etching processes except for the preparation of mask.

Exemplarily, the dielectric modulation principle of oxidizing the sulfide film is as follows: when the material of the sulfide film (antimony sulfide (Sb₂S₃) as an example) is heated to reach the ignition point (typically 290° C. to 340° C.) in air, it easily undergoes a chemical reaction with oxygen in the air to produce antimony trioxide and sulfur dioxide. The chemical equation is:

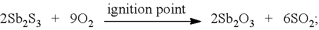

In the near-infrared band from 700 nm to 1700 nm, the refractive index of the antimony trioxide is significantly smaller than that of the antimony sulfide, with a difference of about 1. Moreover, in this band, since the extinction coefficient of the antimony trioxide is less than 0.04, it is a good transparent material with low absorption in the near-infrared band. Based on this, in this embodiment of this application, a laser is allowed to irradiate the surface of the antimony sulfide, so that the antimony sulfide in the irradiated region can heat up itself by absorbing light energy, and then it is oxidized to generate antimony trioxide. Since the lattice of the crystalline antimony trioxide generated by thermal oxidation is cubic with a more stable spatial structure, a uniform oxidation region with different dielectric properties from antimony sulfide can be realized on the surface of the antimony sulfide film. On the other hand, the dielectric constant of the irradiated region satisfies:

$$\frac{{ε}_{eff} - 1}{{ε}_{eff} + 2} = {f}_{Ox} \frac{{ε}_{Ox} - 1}{{ε}_{Ox} + 2} + ( 1 - {f}_{Ox} ) \frac{{ε}_{a} - 1}{{ε}_{a} + 2}$$

where ε_{eff}, ε_{Ox} and εₐ are the effective dielectric constant of the irradiated region, the dielectric constant of antimony trioxide and the refractive index of amorphous antimony sulfide respectively. f_{Ox} is the oxidation proportion of the irradiated region. The laser power may be controlled to adjust the temperature of the antimony sulfide in the irradiated region, so that the oxidation degree of the antimony sulfide can be modulated. In this case, the dielectric constant in the irradiated region can be continuously modulated between amorphous antimony sulfide and antimony trioxide.

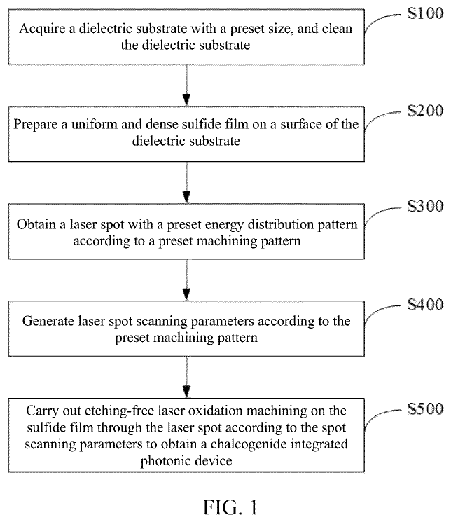

Referring to FIG. 1, FIG. 1 is a schematic flowchart of a laser beam machining method targeted at chalcogenide materials according to this embodiment of this application. The machining method includes the following steps:

S100: Acquire a dielectric substrate with a preset size, and clean the dielectric substrate.

In some implementations, a dielectric substrate meeting the design size requirements is selected, and the surface and back side of the dielectric substrate are cleaned, thereby removing dust particles and organic and inorganic impurities attached to the dielectric substrate.

In some implementations, the flow of cleaning the dielectric substrate includes: ultrasonically cleaning the dielectric substrate in an acetone solution for 15 min, ultrasonically cleaning the dielectric substrate in an isopropanol solution for 15 min, and ultrasonically cleaning the dielectric substrate in an ultrapure water solution for 15 min; and blow-drying the surface and the back side of the dielectric substrate with a high-purity argon gun, and continuously heating the dielectric substrate on a heating plate for 5 min to obtain the clean dielectric substrate. Optionally, according to specific experimental requirements, another film material, such as gold, aluminum oxide or silicon dioxide, may be added to the surface of the dielectric substrate, so that a substrate material required for sulfide coating is obtained.

S200: Prepare a uniform and dense sulfide film on a surface of the dielectric substrate.

Exemplarily, the uniform and dense sulfide film may be prepared on the surface of the dielectric substrate (substrate material) by magnetron sputtering or thermal evaporation.

S300: Obtain a laser spot with a preset energy distribution pattern according to a preset machining pattern.

Exemplarily, the size of single writing field, the number of writing fields and the dielectric modulation requirements in each writing field are determined according to the shape and resolution parameters of the preset machining pattern, and parameters of the machining control program are set according to requirements so as to obtain the laser spot with the preset energy distribution pattern.

S400: Generate laser spot scanning parameters according to the preset machining pattern.

S500: Carry out etching-free laser oxidation machining on the sulfide film through the laser spot according to the spot scanning parameters to obtain a chalcogenide integrated photonic device.

Exemplarily, after the machining system completes the oxidation machining operations in all the pixel regions of the sulfide film, the machining of the sulfide film is completed, and finally, the sulfide film can be taken down.

In some implementations, according to the etching-free laser beam machining method, the laser spot with the preset energy distribution pattern is obtained via the preset machining pattern, and the etching-free laser beam machining is carried out on the sulfide film targeted at the laser spot, so that the oxidation degree of the surface of the sulfide film is accurately modulated on a micro-scale, thereby changing the dielectric constant of the sulfide film. The pattern is nonvolatile and can be formed at one time. Thus, the etching-free laser beam machining method can achieve the technical effect of improving the machining efficiency.

### Embodiment 2

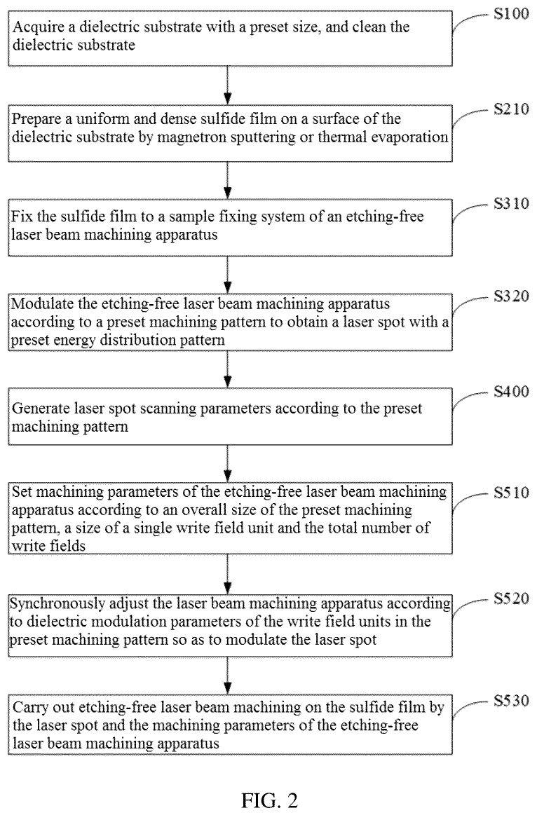

Referring to FIG. 2, FIG. 2 is a schematic flowchart of another laser beam machining method targeted at chalcogenide materials according to this embodiment of this application. The method includes the following steps:

S100: Acquire a dielectric substrate with a preset size, and clean the dielectric substrate.

S210: Prepare a uniform and dense sulfide film on a surface of the dielectric substrate by magnetron sputtering or thermal evaporation.

S310: Fix the sulfide film to a sample fixing system of an etching-free laser beam machining apparatus.

S320: Modulate the etching-free laser beam machining apparatus according to a preset machining pattern to obtain a laser spot with a preset energy distribution pattern.

S400: Generate laser spot scanning parameters according to the preset machining pattern.

S510: Set machining parameters of the etching-free laser beam machining apparatus according to an overall size of the preset machining pattern, a size of a single writing field and the total number of writing fields.

S520: Synchronously adjust the laser beam machining apparatus according to dielectric modulation parameters of the writing fields in the preset machining pattern so as to modulate the laser spot.

S530: Carry out etching-free laser beam machining on the sulfide film by the laser spot and the machining parameters of the etching-free laser beam machining apparatus.

This embodiment is different from Embodiment 1 in that the carrying out etching-free laser oxidation machining on the sulfide film through the laser spot according to the spot scanning parameters to obtain a chalcogenide integrated photonic device in S500 includes:

S510: Set machining parameters of the etching-free laser beam machining apparatus according to an overall size of the preset machining pattern, a size of a single writing field and the total number of writing fields.

S520: Synchronously adjust the laser beam machining apparatus according to dielectric modulation parameters of the writing fields in the preset machining pattern so as to modulate the laser spot.

S530: Carry out etching-free laser beam machining on the sulfide film by the laser spot and the machining parameters of the etching-free laser beam machining apparatus.

Exemplarily, after all the parameters are set, the machining control program is run, and the system automatically and dynamically modulates energy spatial distribution of visible light, irradiation power and movements of the sulfide film in real time according to the set machining parameters. During the operation of the system, the machining parameters set the movements of the sulfide film, so that the irradiated laser spot sequentially moves into the writing field regions of the sulfide film.

Exemplarily, the carry out etching-free laser beam machining on the sulfide film by the laser spot and the machining parameters of the etching-free laser beam machining apparatus in S530 includes:

A continuous-wave laser beam of the laser spot irradiates the surface of the sulfide film, the sulfide in the irradiated region of the sulfide film is heated to 270° C. to 340° C., and the sulfide undergoes a chemical reaction with oxygen in air, so that an oxide is formed in the irradiated region of the sulfide film and sulfur dioxide is released into the air. The refractive index of the sulfide film changes with an amplitude of more than 0.1.

Exemplarily, the continuous-wave laser beam irradiates the surface of the sulfide film to be machined, and the sulfide in the irradiated region, after quickly heated to 270° C. to 340° C. within a hundred nanoseconds, undergoes a chemical reaction with the oxygen in the air, so that antimony oxide is formed in the irradiated region of the film and sulfur dioxide is released into the air. The proportion of oxide in the irradiated region (the laser oxidation degree) is affected by the moving speed of the translation stage and the irradiation power of the laser, so that the refractive index of the film in the irradiated region can be decreased in different amplitudes. In the C band, the maximum decreasing amplitude in refractive index of 0.3 to 0.7 can be realized by decreasing the moving speed of the translation stage or increasing the irradiation power of the laser.

This embodiment is different from Embodiment 1 in that the obtaining a laser spot with a preset energy distribution pattern according to a preset machining pattern in S300 includes:

S310: Fix the sulfide film to a sample fixing system of an etching-free laser beam machining apparatus.

S320: Modulate the etching-free laser beam machining apparatus according to a preset machining pattern to obtain a laser spot with a preset energy distribution pattern.

This embodiment is different from Embodiment 1 in that the preparing a uniform and dense sulfide film on a surface of the dielectric substrate in S200 includes:

S210: Prepare a uniform and dense sulfide film on a surface of the dielectric substrate by magnetron sputtering or thermal evaporation.

In some implementations, the preparing the sulfide film by magnetron sputtering includes, for example, the following steps: A sulfide target is fixed to a cathode. The prepared substrate material is placed onto an anode facing the target surface. When the vacuum degree reaches 5×10−4 Pa, argon is introduced. After the flow of gas becomes stable, an ion source is turned on, a process setup file is called out from a monitoring program, and cleaning is started. After the cleaning is completed, the ion source is turned off, and a direct-current or radio-frequency power supply is adjusted to required power, and coating is started until the end of sputtering.

In some implementations, the preparing the sulfide film by thermal evaporation includes, for example, the following steps: The substrate material is placed on a sample platform of a vacuum coating machine and fixed by a fixture. The vacuum coating machine is evacuated to a vacuum degree of 10⁻⁶ pa, the sulfide target glass is heated in a manner of heating an Tantalum evaporation boat, the film is deposited at an evaporation speed of 0.2-0.8 A/s (preferably, the deposition speed is 0.5 A/s), and the deposition speed and the film thickness are monitored in real time by a film thickness gauge in the coating machine.

Exemplarily, the sulfide film is one or more layers of sulfide films deposited on the surface of the dielectric substrate. The substrate material of the sulfide film is one of quartz glass, crystalline and amorphous silicon, and silicon nitride. The sulfide material of the sulfide film is one of antimony sulfide, germanium tellurium sulfur, germanium tellurium, germanium arsenic sulfur and germanium tellurium selenium.

Exemplarily, before the fixing the sulfide film to a sample fixing system of an etching-free laser beam machining apparatus in S310, the method further includes:
turning on a machining light source of the etching-free laser beam machining apparatus and preheating the machining light source for a preset time to stabilize output power of the machining light source; and
turning on a white light observation system of the etching-free laser beam machining apparatus, the white light observation system being configured to observe the surface of the sulfide film.

Exemplarily, after the turning on a white light observation system of the etching-free laser beam machining apparatus, the method further includes:
adjusting a pitch adjusting stage in the sample fixing system such that the white light observation system is capable of observing the surface of the sulfide film in the whole region to be machined; and
adjusting a rotation adjusting stage in the sample fixing system such that a placement angle of the sulfide film conforms to an angle of the preset machining pattern.

### Embodiment 3

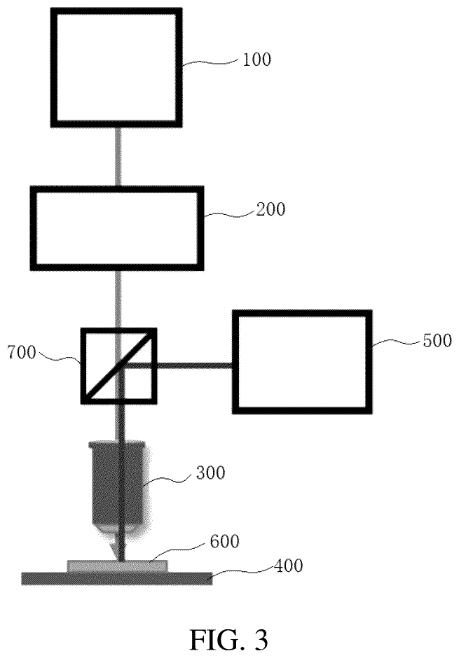

Referring to FIG. 3, FIG. 3 is a schematic structural view of an etching-free laser beam machining apparatus according to this embodiment of this application. The etching-free laser beam machining apparatus is applied to the laser beam machining method targeted at chalcogenide materials in FIG. 1 to FIG. 2. The etching-free laser beam machining apparatus includes a machining light source 100, a beam modulation system 200, a convergence system 300, a sample fixing system 400 and a white light observation system 500.

Exemplarily, the machining light source 100 is configured to output a laser beam.

In some implementations, the machining light source 100 is a continuous-wave laser in the visible light band, with a laser power of ≥300 mW and a beam quality of M2<1.2.

Exemplarily, the beam modulation system 200 is arranged at an exit end of the machining light source 100 and configured to modulate the laser beam into a laser spot with a preset energy distribution pattern.

Exemplarily, the convergence system 300 is arranged at an exit end of the beam modulation system 200 and configured to converge the laser spot and image the laser spot to a surface of a to-be-machined sample 600.

In some implementations, the convergence system 300 images a spot with specific energy distribution to a back focal plane of an objective lens through a lens imaging system, and then the spot perpendicularly exits an entrance pupil of the objective lens, so that the spot is scaled down by the objective lens and imaged on a working distance plane of the objective lens, thereby obtaining a scaled-down laser spot with specific energy distribution.

Exemplarily, the to-be-machined sample 600 is the sulfide film.

Exemplarily, the sample fixing system 400 is arranged at an exit end of the convergence system 300 and configured to fix the to-be-machined sample 600.

Exemplarily, the white light observation system 500 is arranged between the beam modulation system 200 and the convergence system 300 and configured to observe morphology of the machining region of the to-be-machined sample 600.

Exemplarily, the sample fixing system 400 includes a three-axis translation stage, a pitch adjusting stage and a rotation adjusting stage which are sequentially stacked. The three-axis translation stage is configured to control a machining position of the to-be-machined sample 600. The pitch adjusting stage is configured to adjust a pitch angle of the to-be-machined sample 600. The rotation adjusting stage is configured to adjust a rotation angle of the to-be-machined sample 600.

Exemplarily, the etching-free laser beam machining apparatus further includes a motorized power attenuator and a high-speed optical switch. The motorized power attenuator is connected with the machining light source 100 and configured to modulate a laser power of the laser beam. The high-speed optical switch is connected with the machining light source 100 and configured to modulate an on/off state of the beam.

Exemplarily, the white light observation system 500 further includes a beam splitter 700. The beam splitter 700 is arranged between the beam modulation system 200 and the convergence system 300. The beam splitter 700 is configured to combine a collimated and parallel white light beam and the laser beam. The white light beam is used to irradiate the machining region of the to-be-machined sample 600, and the white light reflected beam of the to-be-machined sample 600 is irradiated onto the white light observation system 500 via the beam splitter 700.

In some implementations, the beam modulation system 200 first transforms, through a specific beam transformation phase plate, a Gaussian beam outputted by the semiconductor laser into a flat top beam, the energy of which is relatively uniform within the entire spot range. Then, the flat top beam is expanded, such that the spot size is satisfactory for a beam shaping device. Finally, the energy distribution of the beam is modulated by the beam shaping device, and the laser beam is modulated into a specific energy distribution pattern according to the pattern to be machined. At the same time, the motorized power attenuator and the high-speed optical switch are used to dynamically modulate the laser power and the on/off state of the machining laser beam in real time.

In some implementations, the sample fixing system 400 performs fixing control on the sulfide film sample to be machined through a three-axis motorized precision translation stage, a manual pitch adjusting stage and a rotation adjusting stage. The three-axis motorized precision translation stage is configured to control the machining position of the sample, and automatically move the position of the sample according to settings of the machining program. The manual pitch adjusting stage and the rotation adjusting stage are configured to manually adjust the pitch and rotation angles of the sample before machining, such that the initial spatial position of the sample meets the machining requirements.

Exemplarily, the white light observation system 500 combines the collimated and parallel white light beam and the machining laser beam through the R:T=10:90 beam splitter 700. The white light beam is used to irradiate the machining region of the sample, and then a CCD is used to observe the white light reflected beam, such that a reflective white light imaging microscope is built to observe morphology of the machining region in real time.

In some implementations, the sulfide film to be machined is placed on a working plane of the objective lens, and the machining spot converges and then irradiates the surface of the film to be machined. Due to the changes in laser energy density, irradiation time and other parameters, the oxidation degree of the film in the irradiated region changes, and its dielectric modulation depth varies. By modulating the laser spot energy distribution on the surface of the film to be machined and the three-axis motorized precision translation stage, the surface of the sulfide film can be oxidized into any specific pattern.

In this embodiment of this application, the continuous-wave laser beam is typically obtained from a semiconductor laser, and the laser wavelength should be selected within the light absorption band of the sulfide material. Moreover, with the increase of the machining accuracy, due to the limitation of the diffraction limit, it is necessary to select a short wavelength laser beam so as to acquire a smaller laser spot.

### Embodiment 4

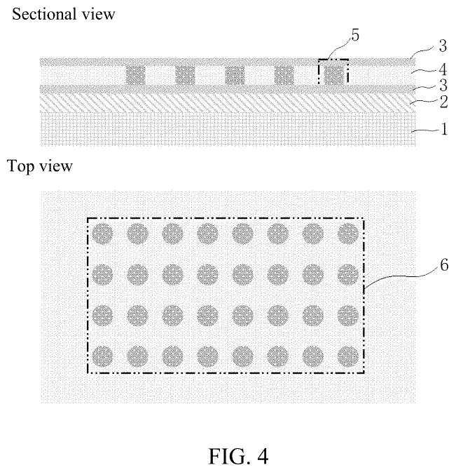

Referring to FIG. 4, FIG. 4 shows schematic structural views of a chalcogenide planar integrated photonic device prepared by etching-free laser oxidation machining according to this embodiment of this application. The chalcogenide material planar device is machined by the etching-free laser beam machining apparatus of FIG. 3 in combination with the etching-free laser oxidation machining method of FIG. 2.

Exemplarily, the sample substrate is a crystalline silicon substrate 1; a gold reflective layer 2 is deposited on a surface of the silicon substrate 1; the gold reflective layer 2 is prepared by electron beam evaporation; an aluminum oxide 3 low refractive index layer is deposited on a surface of the gold reflective layer 2; the aluminum oxide 3 low refractive index layer is prepared by atomic layer deposition; the planar device chalcogenide material is antimony sulfide 4; and the chalcogenide material is prepared by magnetron sputtering.

Exemplarily, during the etching-free laser beam machining process, the laser spot is circular light; the energy distribution of the laser spot is a Gaussian distribution; the oxidation region of the laser spot is circular; and the etching-free laser beam machining pattern is a two-dimensional circular array structure with a fixed period.

Exemplarily, after the machining of the chalcogenide planar integrated photonic device is completed, a surface of the chalcogenide material is covered with a single aluminum oxide 3 protective layer; and the aluminum oxide 3 protective layer is prepared by atomic layer deposition.

### Embodiment 5

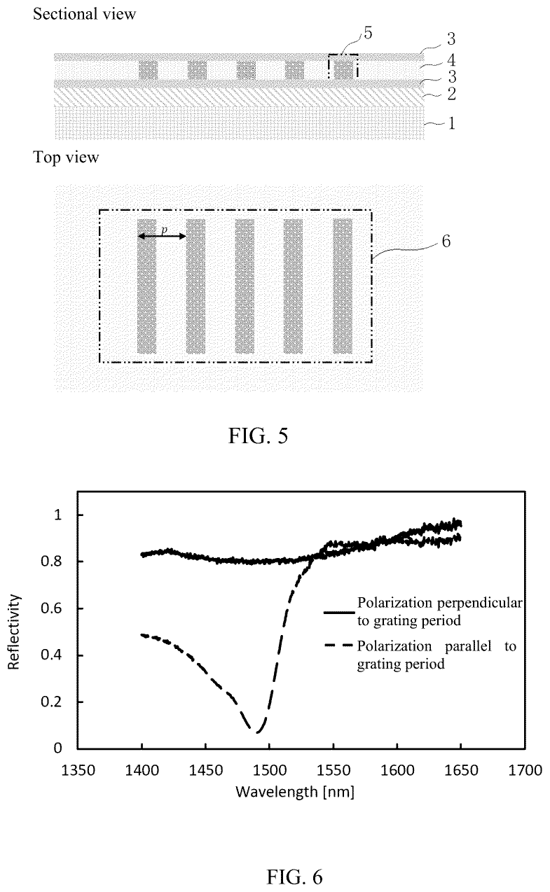

Referring to FIG. 5, FIG. 5 shows schematic structural views of a chalcogenide material near-infrared band linear planar polarizer device prepared by etching-free laser beam machining according to this embodiment of this application. The chalcogenide material planar device is machined by the etching-free laser beam machining apparatus of FIG. 3 in combination with the etching-free laser oxidation machining method of FIG. 2.

Exemplarily, the sample substrate is a crystalline silicon substrate 1; a gold reflective layer 2 is deposited on a surface of the silicon substrate 1; the gold reflective layer 2 is prepared by electron beam evaporation; the gold reflective layer 2 has a thickness of 100 nm; an aluminum oxide 3 low refractive index layer is deposited on a surface of the gold reflective layer 2; the aluminum oxide 3 low refractive index layer is prepared by atomic layer deposition; the aluminum oxide 3 low refractive index layer has a thickness of 10 nm; the planar device chalcogenide material is antimony sulfide 4; the chalcogenide material is prepared by magnetron sputtering; and the layer of antimony sulfide 4 has a thickness of 100 nm.

Exemplarily, during the etching-free laser beam machining process, the laser wavelength is 405 nm; the laser spot is circular in shape; and the energy distribution of the laser spot is Gaussian distribution.

Exemplarily, the etching-free laser beam machining pattern is a one-dimensional linear grating array structure with a fixed period, and the grating period p is 2 μm.

Exemplarily, after the machining of the chalcogenide material planar device is completed, a surface of the chalcogenide material is covered with a single aluminum oxide 3 protective layer; and the aluminum oxide 3 protective layer is prepared by atomic layer deposition.

Exemplarily, for the reflectivity spectra of the near-infrared polarizer, reference may be made to FIG. 6. When the polarization direction of the incident light field is parallel to the grating period direction, the reflectivity of the polarizer is close to 0 in the 1500 nm band, and when the polarization direction of the incident light field is perpendicular to the grating period direction, the reflectivity of the polarizer is close to 1 in the near-infrared band.

### Embodiment 6

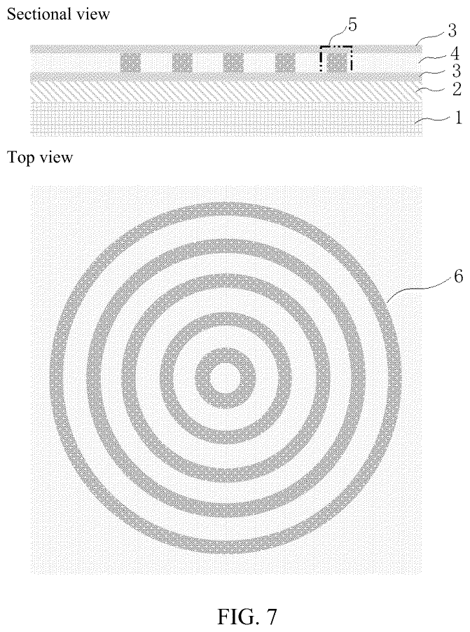

Referring to FIG. 7, FIG. 7 shows schematic structural views of a chalcogenide planar Fresnel zone plate prepared by etching-free laser oxidation machining according to this embodiment of this application. The chalcogenide material planar device is machined by the etching-free laser beam machining apparatus of FIG. 3 in combination with the etching-free laser oxidation machining method of FIG. 2.

Exemplarily, the sample substrate is a crystalline silicon substrate 1; a gold reflective layer 2 is deposited on a surface of the silicon substrate 1; the gold reflective layer 2 is prepared by electron beam evaporation; the gold reflective layer 2 has a thickness of 100 nm; an aluminum oxide 3 low refractive index layer is deposited on a surface of the gold reflective layer 2; the aluminum oxide 3 low refractive index layer is prepared by atomic layer deposition; the aluminum oxide 3 low refractive index layer has a thickness of 10 nm; the planar device chalcogenide material is antimony sulfide 4; the chalcogenide material is prepared by magnetron sputtering; and the layer of antimony sulfide 4 has a thickness of 100 nm.

Exemplarily, during the etching-free laser beam machining process, the laser wavelength is 405 nm; the laser spot is circular in shape; and the energy distribution of the laser spot is Gaussian distribution.

Exemplarily, the machining pattern of the etching-free laser beam machining region is a concentric ring formed by a two-dimensional lattice with a fixed period, and the period of the two-dimensional lattice is 1.03 um.

Exemplarily, after the machining of the near-infrared Fresnel lens is completed, a surface of the chalcogenide material is covered with a single aluminum oxide 3 protective layer; and the aluminum oxide 3 protective layer is prepared by atomic layer deposition.

Exemplarily, for the reflectivity distribution of the near-infrared Fresnel zone plate in the near-infrared working band, reference may be made to FIG. 8. The reflectivity of the array structure prepared by etching-free laser beam machining is close to 0 at the wavelength of 1550 nm, and the reflectivity of the unexposed region is close to 1 at the wavelength of 1550 nm, thereby realizing the periodic modulation of the intensity distribution of the reflected light field and completing the focusing of the reflected light field.

### Embodiment 7

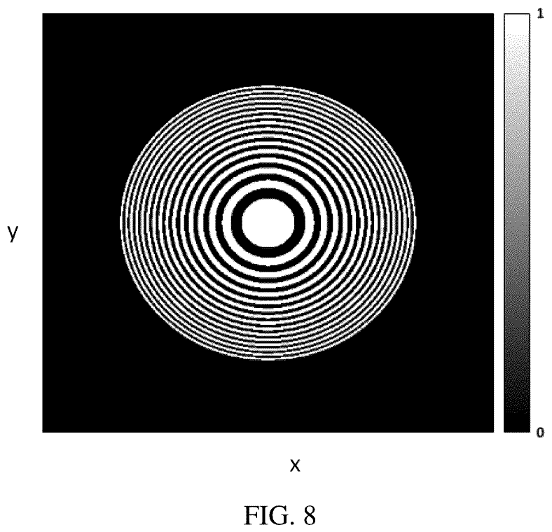

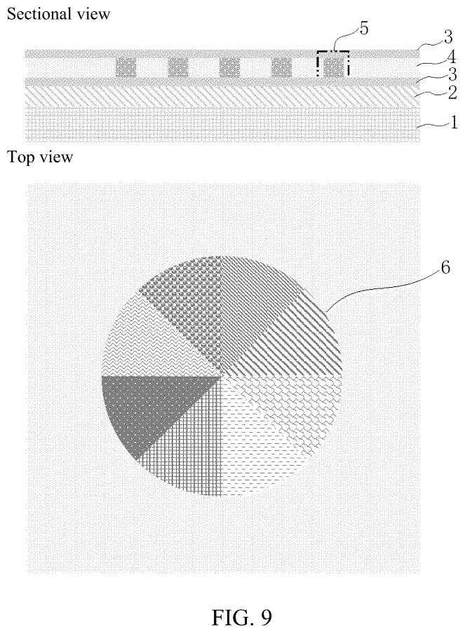

Referring to FIG. 9, FIG. 9 shows schematic structural views of a chalcogenide planar first-order OAM phase plate prepared by etching-free laser oxidation machining according to this embodiment of this application. The chalcogenide material planar device is machined by the etching-free laser beam machining apparatus of FIG. 3 in combination with the etching-free laser oxidation machining method of FIG. 2.

Exemplarily, the sample substrate is a crystalline silicon substrate 1; a gold reflective layer 2 is deposited on a surface of the silicon substrate 1; the gold reflective layer 2 is prepared by electron beam evaporation; the gold reflective layer 2 has a thickness of 100 nm; an aluminum oxide 3 low refractive index layer is deposited on a surface of the gold reflective layer 2; the aluminum oxide 3 low refractive index layer is prepared by atomic layer deposition; the aluminum oxide 3 low refractive index layer has a thickness of 10 nm; the planar device chalcogenide material is antimony sulfide 4; the chalcogenide material is prepared by magnetron sputtering; and the layer of antimony sulfide 4 has a thickness of 100 nm.

Exemplarily, during the etching-free laser beam machining process, the laser wavelength is 405 nm; the laser spot is circular in shape; and the energy distribution of the laser spot is Gaussian distribution.

Exemplarily, the etching-free laser beam machining region is formed by 8 concentric sectors; each sector region has a two-dimensional lattice structure with a fixed period; and the periods of the lattices inside the 8 sector structures are different, which are 1.015, 1.03, 1.045, 1.06, 1.075, 1.09, 1105 and 1.12 um respectively.

Exemplarily, after the machining of the chalcogenide material first-order OAM phase plate is completed, a surface of the chalcogenide material is covered with a single aluminum oxide 3 protective layer; the aluminum oxide 3 protective layer is prepared by atomic layer deposition; and the aluminum oxide 3 protective layer has a thickness of 10 nm.

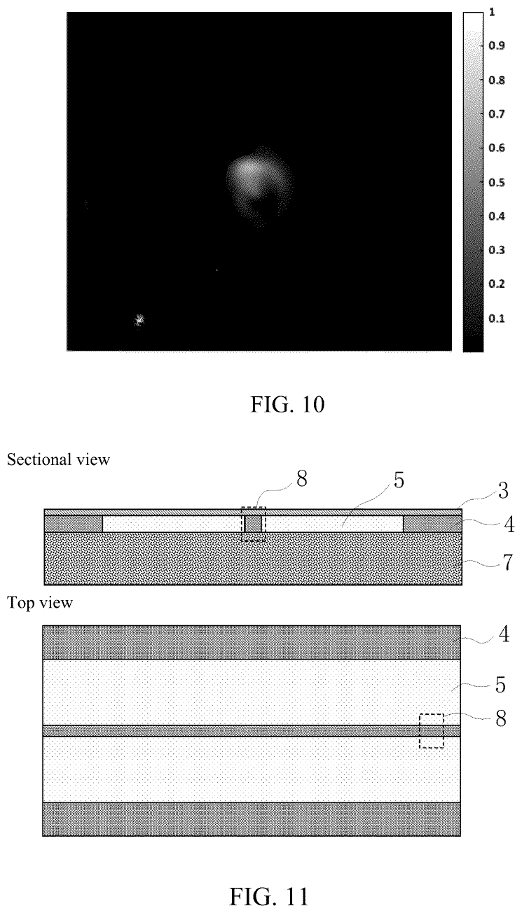

Exemplarily, for the reflected far-field light intensity distribution of the near-infrared first-order OAM phase plate, reference may be made to FIG. 10.

### Embodiment 8

Referring to FIG. 11, FIG. 11 shows schematic structural views of a chalcogenide planar waveguide 8 prepared by etching-free laser oxidation machining according to this embodiment of this application. The chalcogenide material planar device is machined by the etching-free laser beam machining apparatus of FIG. 3 in combination with the etching-free laser oxidation machining method of FIG. 2.

Exemplarily, the sample substrate is a silicon dioxide substrate 7; a layer of antimony sulfide 4 is deposited on a surface of the silicon dioxide substrate 7; the layer of antimony sulfide 4 has a thickness of 400 nm; and the antimony sulfide 4 is prepared by magnetron sputtering.

Exemplarily, during the etching-free laser beam machining process, the laser wavelength is 405 nm; the laser spot is circular in shape; and the energy distribution of the laser spot is Gaussian distribution.

The machining pattern of the etching-free laser region is two strip patterns arranged in parallel; the strip machining patterns each have a width of about 3 μm; and a distance between the two machining patterns is about 500 nm.

Exemplarily, after the machining of the chalcogenide material waveguide 8 is completed, a surface of the chalcogenide material is covered with a single aluminum oxide 3 protective layer; the aluminum oxide 3 protective layer is prepared by atomic layer deposition; and the aluminum oxide 3 protective layer has a thickness of 30 nm.

Exemplarily, in the near-infrared communication band, after the antimony sulfide 4 material is subjected to etching-free laser beam machining, the refractive index of the material is significantly lower than that of the exposed region, and significantly higher than that of the aluminum oxide 3 protective layer and air. Therefore, the near-infrared band light field can be well bound in the unexposed antimony sulfide 4 structure in the middle part of the exposed pattern, thereby realizing on-chip optical transmission.

Under the excitation of an external optical or electric signal, the intrinsic refractive index of the antimony sulfide 4 material provided by this embodiment of this application is dynamically adjustable. Therefore, by the aid of the external excitation signal, the refractive index of the antimony sulfide 4 material in the waveguide 8 region in the antimony sulfide 4 on-chip waveguide 8 device can be changed, so that the effective refractive index in the waveguide 8 mode can be flexibly modulated.

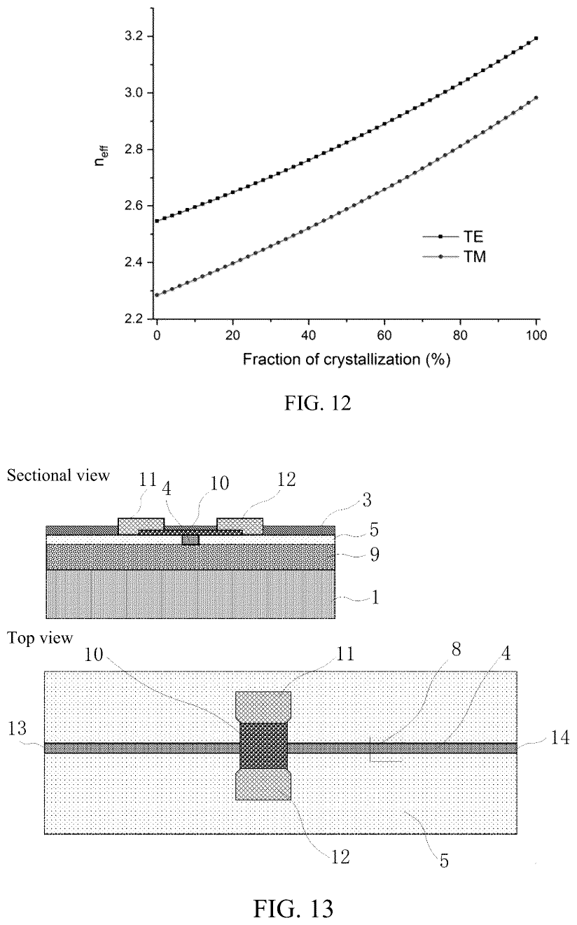

Exemplarily, for the dynamic modulation effect of the effective refractive index of the antimony sulfide 4 waveguide 8 in the waveguide 8 mode under the excitation of the external signal, reference may be made to FIG. 12.

### Embodiment 9

On the basis of Embodiment 8, this embodiment of this application provides an on-chip optical phase shifter targeted at a chalcogenide material planar waveguide. FIG. 13 shows schematic structural views of a chalcogenide planar waveguide type phase-change optical phase shifter prepared by etching-free laser oxidation machining according to this embodiment of this application. The chalcogenide material planar device is machined by the etching-free laser beam machining apparatus of FIG. 3 in combination with the etching-free laser oxidation machining method of FIG. 2.

Exemplarily, the on-chip optical phase shifter includes, from bottom to top, a silicon substrate 1, a silicon dioxide buffer layer 9, an antimony sulfide 4 planar waveguide 8 layer, a graphene heating plate 10, an aluminum oxide 3 coating layer, a metal P-electrode 12 and a metal N-electrode 11. The antimony sulfide 4 planar waveguide 8 is prepared by the machining method according to Embodiment 8.

Under the excitation of an external optical or electric signal, the intrinsic refractive index of the antimony sulfide 4 material provided by this embodiment of this application is dynamically adjustable. Therefore, by the aid of the external electric pulse signal, by injecting the metal P-electrode 12 and the metal N-electrode 11 into the graphene heating plate 10 with high thermal conductivity, the antimony sulfide 4 waveguide 8 is heated through the resistance thermal effect, which causes its phase change. By modulating the effective refractive index of the antimony sulfide 4 waveguide 8 with a fixed length, dynamic phase shift modulation of the propagation phase of the optical signal transmitted via the waveguide 8 with an amplitude of not less than 2× can be realized.

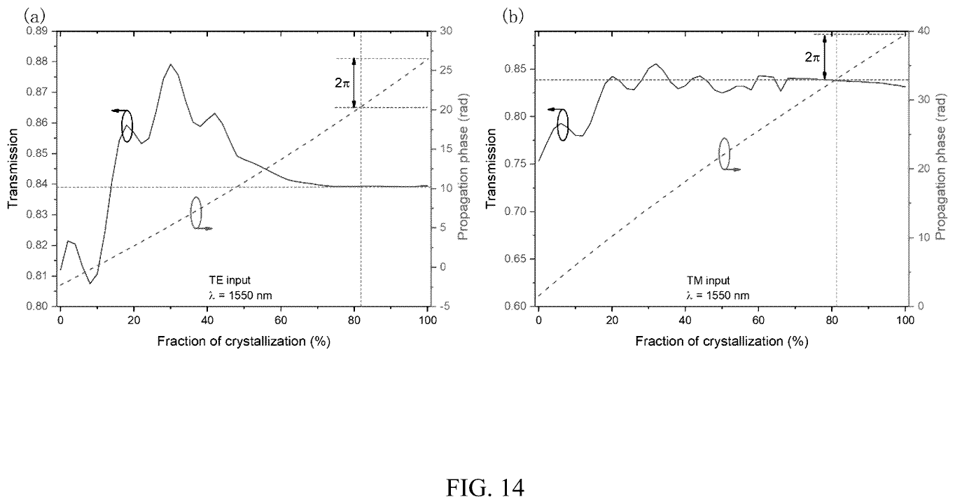

Exemplarily, for the dynamic phase modulation effect of the phase shifter, reference may be made to FIG. 14.

### Embodiment 10

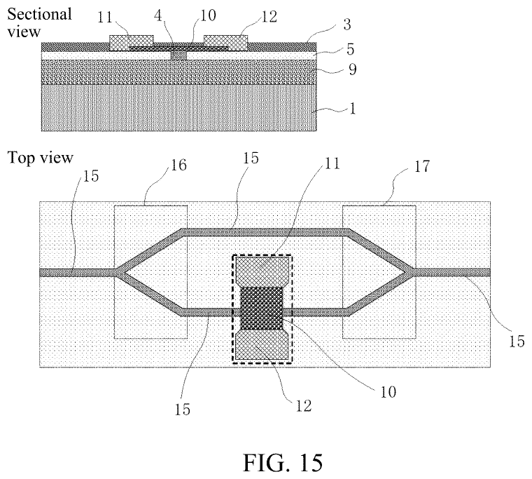

On the basis of Embodiment 8, this embodiment of this application provides an on-chip Mach-Zehnder interference optical switch targeted at a chalcogenide material planar waveguide 8. FIG. 15 shows schematic structural views of a chalcogenide planar waveguide type Mach-Zehnder interference optical switch prepared by etching-free laser oxidation machining according to this embodiment of this application. The chalcogenide material planar device is machined by the etching-free laser beam machining apparatus of FIG. 3 in combination with the etching-free laser oxidation machining method of FIG. 2.

Exemplarily, the on-chip Mach-Zehnder interference optical switch includes, from bottom to top, a silicon substrate 1, a silicon dioxide buffer layer 9, an antimony sulfide 4 waveguide layer (including a straight waveguide 15 at an input terminal, a beam-splitting waveguide 16, a straight waveguide 15 at an intermediate terminal, a beam-combining waveguide 17 and a straight waveguide 15 at an output terminal), a graphene heating plate 10, an aluminum oxide 3 coating layer, a metal N-electrode 11 and a metal P-electrode 12. The antimony sulfide 4 planar waveguide is prepared by the machining method according to Embodiment 8.

Under the excitation of an external optical or electric signal, the intrinsic refractive index of the antimony sulfide 4 material provided by this embodiment of this application is dynamically adjustable. Therefore, by the aid of the external electric pulse signal, by injecting the metal N-electrode 11 and the metal P-electrode 12 into the graphene heating plate 10 with high thermal conductivity, the antimony sulfide 4 waveguide is heated through the resistance thermal effect, which causes its phase change. By modulating the effective refractive index of the antimony sulfide 4 waveguide with a fixed length, an effective phase shift of the propagation phase of the optical signal transmitted via the straight waveguide 15 with an amplitude of not less than π can be realized. Based on the Mach-Zehnder interference principle, wide-range dynamic modulation of the transmission of the optical signal at the output terminal at the straight waveguide 15 is realized.

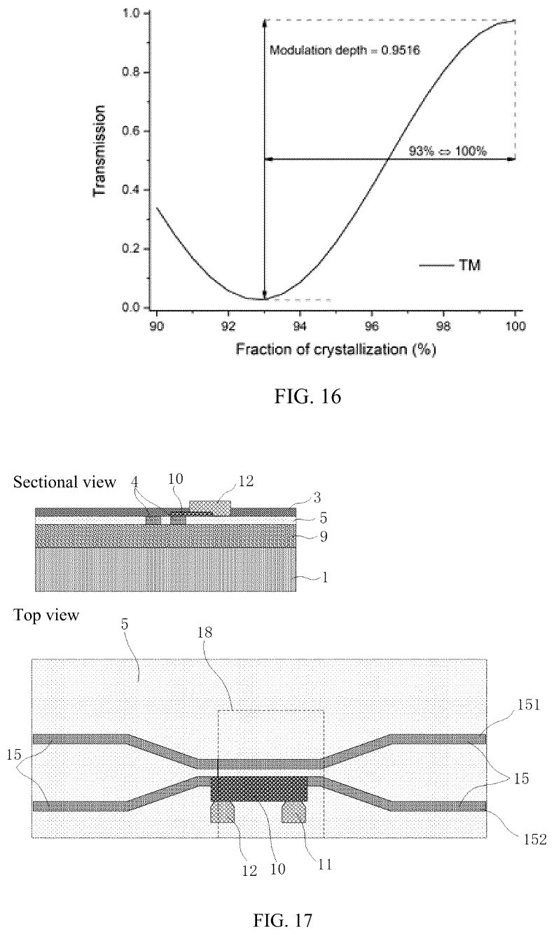

Exemplarily, for the dynamic modulation effect of the Mach-Zehnder interference optical switch according to this embodiment of this application, reference may be made to FIG. 16.

### Embodiment 11

On the basis of Embodiment 8, this embodiment of this application provides a splitting-ratio-adjustable on-chip beam-splitting optical switch targeted at a chalcogenide material planar waveguide 8. FIG. 17 shows schematic structural views of a chalcogenide planar splitting-ratio-adjustable on-chip beam-splitting optical switch prepared by etching-free laser oxidation machining according to this embodiment of this application. The chalcogenide material planar device is machined by the etching-free laser beam machining apparatus of FIG. 3 in combination with the etching-free laser oxidation machining method of FIG. 2.

Exemplarily, the splitting-ratio-adjustable on-chip beam-splitting optical switch includes, from bottom to top, a silicon substrate 1, a silicon dioxide buffer layer 9, an antimony sulfide 4 waveguide 8 layer (including a straight waveguide 15 at an input terminal, an evanescent coupling waveguide 18 and a straight waveguide 15 at an output terminal, where the straight waveguide 15 at the output terminal includes a first output straight waveguide 151 and a second output straight waveguide 152), a graphene heating plate 10, an aluminum oxide 3 coating layer, a metal N-electrode 11 and a metal P-electrode 12. The antimony sulfide 4 planar waveguide is prepared by the machining method according to Embodiment 8.

Under the excitation of an external optical or electric signal, the intrinsic refractive index of the antimony sulfide 4 material provided by this embodiment of this application is dynamically adjustable. Therefore, by the aid of the external electric pulse signal, by injecting the metal N-electrode 11 and the metal P-electrode 12 into the graphene heating plate 10 with high thermal conductivity, the effective refractive index of the single antimony sulfide 4 evanescent coupling waveguide 18 with a fixed length can be modulated, so that the optical signal intensity ratio in the first output straight waveguide 151 and the second output straight waveguide 152 is arbitrarily adjustable.

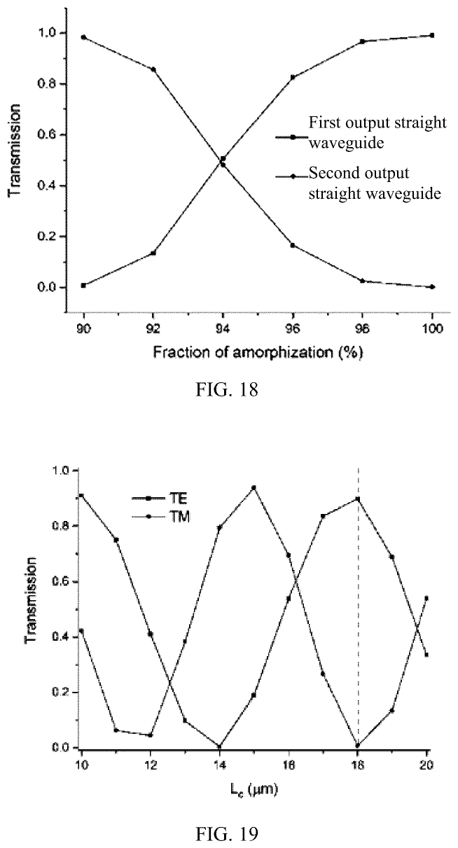

Exemplarily, for the dynamic modulation effect of the splitting-ratio-adjustable on-chip beam-splitting optical switch according to this embodiment of this application, reference may be made to FIG. 18.

Further, according to the splitting-ratio-adjustable on-chip beam-splitting optical switch device provided by this embodiment of this application, by modulating the effective refractive index of the single antimony sulfide 4 evanescent coupling waveguide 18 with a fixed length, polarization beam-splitting can be carried out on the optical signal inputted from the straight waveguide 15 at the input terminal. TE-polarized and TM-polarized optical signals can be respectively outputted from the first output straight waveguide 151 and the second output straight waveguide 152. At this time, the polarization state of the optical signal of the waveguide is changed through external modulation so as to adjust the intensity ratio of the TE and TM optical signals, and then the optical signals are inputted into the waveguide device, thereby realizing the dynamic modulation of the splitting ratio by polarization beam-splitting.

Exemplarily, for the polarization beam-splitting dynamic modulation effect of the splitting-ratio-adjustable on-chip beam-splitting optical switch according to this embodiment of this application, reference may be made to FIG. 19.

In all the embodiments of this application, “bigger” and “smaller” are relative terms, “more” and “less” are relative terms, and “upper” and “lower” are relative terms. The embodiments of this application will not elaborate on the expression of such relative terms.

It should be understood that references to “in this embodiment”, “in this embodiment of this application” or “as an optional implementation” throughout the specification mean that specific features, structures or characteristics related to an embodiment are included in at least one embodiment of this application. Therefore, “in this embodiment”, “in this embodiment of this application” or “as an optional implementation” appearing throughout the specification may not necessarily refer to the same embodiment. In addition, these specific features, structures or characteristics may be combined in one or more embodiments in any suitable manner. Those skilled in the art shall also know that the embodiments described in the specification are all optional embodiments, and the actions and modules involved are not necessarily necessary for this application.

It should be understood that in various embodiments of this application, an order of sequence numbers of the foregoing processes does not indicate a necessary execution sequence, and execution sequences of the processes shall be determined according to functions and internal logics thereof and shall not impose any limitation on an implementation process of the embodiments of this application.

The foregoing descriptions are merely specific implementations of this application, but the protection scope of this application is not limited thereto. Any variation or replacement readily figured out by those skilled in the art within the technical scope disclosed in this application shall fall within the protection scope of this application. Therefore, the protection scope of this application shall be subject to the protection scope of the claims.

1. A laser beam machining method targeted at chalcogenide materials, characterized by comprising following steps:
acquiring a dielectric substrate with a preset size, and cleaning the dielectric substrate;
preparing a uniform and dense sulfide film on a surface of the dielectric substrate;
obtaining a laser spot with a preset energy distribution pattern according to a preset machining pattern;
generating laser spot scanning parameters according to the preset machining pattern; and
carrying out etching-free laser oxidation machining on the sulfide film through the laser spot according to the laser spot scanning parameters to obtain a chalcogenide integrated photonic device.

2. The laser beam machining method targeted at chalcogenide materials according to claim 1, characterized in that, an extinction coefficient of a sulfide material of the sulfide film in a target band is greater than or equal to 0.05, and the sulfide material is one or more of antimony sulfide, germanium tellurium sulfur, germanium antimony tellurium, germanium arsenic sulfur and germanium tellurium selenium, the target band being one of a visible light band, a short wave infrared band, a medium wave infrared band and a long wave infrared band.

3. The laser beam machining method targeted at chalcogenide materials according to claim 2, characterized in that, a laser light source of the laser spot is a continuous-wave laser, and a wavelength of the continuous-wave laser is any one of wavelengths with the extinction coefficient of the sulfide material being greater than or equal to 0.05.

4. The laser beam machining method targeted at chalcogenide materials according to claim 1, characterized in that, a machining region of the sulfide film is heated up under the irradiation of the laser spot, and the machining region heated reacts with oxygen ions in a machining environment and undergoes oxidation, the machining environment comprising one or more of air, oxygen, water and an oxygen ion solution; a first material refractive index of an irradiated region of the sulfide film before oxidation is different from a second material refractive index after oxidation, and a difference between the first material refractive index and the second material refractive index in a working band is not less than 0.1.

5. The laser beam machining method targeted at chalcogenide materials according to claim 1, characterized in that, the preset machining pattern is obtained by changing energy distribution of the laser spot and changing a scanning mode of the laser spot.

6. The laser beam machining method targeted at chalcogenide materials according to claim 1, characterized in that, an oxidation degree of the material in the machining region of the laser spot is modulated in multiple stages by adjusting energy, an irradiation time and the scanning mode of the laser spot.

7. The laser beam machining method targeted at chalcogenide materials according to claim 6, characterized in that, a first film thickness of the machining region of the sulfide film before laser beam machining is only slightly different from a second film thickness after laser beam machining, and a ratio of the second film thickness to the first film thickness is 0.8 to 1.2.

8. The laser beam machining method targeted at chalcogenide materials according to claim 1, characterized in that, the preset machining pattern comprises one or more of a circle, an ellipse, a rectangle, a cross, a circular ring, an elliptical ring, a square ring, a negative cross pattern, a circular array, an elliptical array, a rectangular array, a cross array, a circular ring array, an elliptical ring array, a square ring array and a negative cross pattern array.

9. The laser beam machining method targeted at chalcogenide materials according to claim 1, characterized in that, if the chalcogenide materials of the sulfide film selected have phase-change characteristics, then the integrated photonic device prepared by the laser oxidation machining has a characteristic of programmable and nonvolatile optical response, and the phase-change material comprises one or more of antimony sulfide and antimony selenide.

10. An integrated photonic device, characterized in that the integrated photonic device is prepared by the laser beam machining method targeted at chalcogenide materials according to claim 1, wherein during the preparation of the integrated photonic device, additional exposure and etching with or without a mask is not needed to be introduced.

11. The integrated photonic device according to claim 10, characterized in that an extinction coefficient of a sulfide material of the sulfide film in a target band is greater than or equal to 0.05, and the sulfide material is one or more of antimony sulfide, germanium tellurium sulfur, germanium antimony tellurium, germanium arsenic sulfur and germanium tellurium selenium, the target band being one of a visible light band, a short wave infrared band, a medium wave infrared band and a long wave infrared band.

12. The integrated photonic device according to claim 10, characterized in that a laser light source of the laser spot is a continuous-wave laser, and a wavelength of the continuous-wave laser is any one of wavelengths with the extinction coefficient of the sulfide material being greater than or equal to 0.05.

13. The integrated photonic device according to claim 10, characterized in that a machining region of the sulfide film is heated up under the irradiation of the laser spot, and the machining region heated reacts with oxygen ions in a machining environment and undergoes oxidation, the machining environment comprising one or more of air, oxygen, water and an oxygen ion solution; a first material refractive index of an irradiated region of the sulfide film before oxidation is different from a second material refractive index after oxidation, and a difference between the first material refractive index and the second material refractive index in a working band is not less than 0.1.

14. The integrated photonic device according to claim 10, characterized in that the preset machining pattern is obtained by changing energy distribution of the laser spot and changing a scanning mode of the laser spot.

15. The integrated photonic device according to claim 10, characterized in that an oxidation degree of the material in the machining region of the laser spot is modulated in multiple stages by adjusting energy, an irradiation time and the scanning mode of the laser spot.

16. The integrated photonic device according to claim 10, characterized in that a first film thickness of the machining region of the sulfide film before laser beam machining is only slightly different from a second film thickness after laser beam machining, and a ratio of the second film thickness to the first film thickness is 0.8 to 1.2.

17. The integrated photonic device according to claim 10, characterized in that the preset machining pattern comprises one or more of a circle, an ellipse, a rectangle, a cross, a circular ring, an elliptical ring, a square ring, a negative cross pattern, a circular array, an elliptical array, a rectangular array, a cross array, a circular ring array, an elliptical ring array, a square ring array and a negative cross pattern array.

18. The integrated photonic device according to claim 10, characterized in that if the chalcogenide materials of the sulfide film selected have phase-change characteristics, then the integrated photonic device prepared by the laser oxidation machining has a characteristic of programmable and nonvolatile optical response, and the phase-change material comprises one or more of antimony sulfide and antimony selenide.

19. The laser beam machining method targeted at chalcogenide materials according to claim 5, characterized in that, an oxidation degree of the material in the machining region of the laser spot is modulated in multiple stages by adjusting energy, an irradiation time and the scanning mode of the laser spot.
